(19) United States
(12) Patent Application Publication
(10) Pub. No.: US 2002/0066487 A1
(43) Pub. Date: Jun. 6, 2002

(54) Charging and evacuation valve

(75) Inventors: Robert B. Danielson, Mahtomedi, MN (US); Stanlee W. Meisinger, Golden Valley, MN (US)

Correspondence Address: MERCHANT & GOULD PC, P.O. BOX 2903, MINNEAPOLIS, MN, 55402-0903, US

(73) Assignee: FASTEST, INC.

(21) Appl. No.: 09/975,911

(22) Filed: Oct. 11, 2001

Related U.S. Application Data
(60) Provisional application No. 60/241,758, filed on Oct. 16, 2000.

(51) Int. Cl. F16K 15/00

(52) U.S. Cl. 137/541

(57) ABSTRACT

Valves, particularly service connection valves for use with a refrigeration system and the like, to permit charging, evacuation and/or testing of the system, are disclosed. In one embodiment, the valve includes a valve seat, a valve body detachably connected to the valve seat, and a valve core detachably secured within the valve body. The valve body and valve core are removable together as a single unit from the valve seat. In another embodiment, the valve includes a valve seat, a valve body detachably connected to the valve seat, and a cap that are designed so that the action of unscrewing the cap from the valve body will never cause the valve body to be unscrewed from the valve seat. Therefore, unscrewing the cap from the valve body will never loosen the connection between the valve body and the valve seat, thereby preventing leakage between the valve body and valve seat.

This application claims the benefit of U.S. Provisional Application No. 60/241,758, filed Oct. 16, 2000.

### FIELD OF THE INVENTION

The present invention relates generally to refrigeration systems, such as air conditioning units, refrigerators, and like systems that utilize a refrigerant for cooling. More particularly, the present invention relates to a valve used for charging and/or evacuation of such systems.

### BACKGROUND OF THE INVENTION

Refrigeration systems, such as air conditioning units and the like, employ a refrigerant contained in a closed loop system to provide cooling. Access to the closed loop system is commonly provided by a service connection, or service valve block. The service connection is valved to permit charging and/or evacuation of the closed loop system for a variety of purposes by manufacturing personnel during manufacture or by service personnel in the field.

A desirable feature of a service connection valve of a refrigeration system is the ability to permit high flow rates both into the closed loop system during charging as well as out of the closed loop system during evacuation. In addition to permitting high flow rates, the valve should also be replaceable in the event of a failure of one or more of the valve components, such as a seal.

A high flow valve is disclosed in U.S. Pat. No. 6,050,295. One embodiment of the valve disclosed therein includes a first body member and a second body member detachably connected to the first body member. A valve assembly is secured to the second body member for controlling flow through the valve. The second body member and valve assembly are removable together as a single unit from the first body member. Therefore, if the valve assembly fails and needs replacement, the second body member and valve assembly can be removed as a unit from the valve and replaced with either a new or the same second body member, and a new valve assembly.

U.S. Pat. No. 6,050,295 also discloses a service connection that utilizes a valve core, often called a Schrader valve, for controlling access to a closed loop cooling system of a refrigeration system. As described therein, the flow rate provided by a valve core is generally lower than the flow rates provided by the high flow valves disclosed in the patent. However, valve cores are widely used in a variety of industries and they are therefore plentiful and inexpensive. Due to the relatively low cost of, and ready access to, valve cores, it is anticipated that the lower cost of using a valve core in a service connection, and the consequent lower flow rate provided thereby, sometimes can outweigh the benefits of a higher flow rate provided by a high flow valve such as disclosed in U.S. Pat. No. 6,050,295.

Further, refrigerant is recognized as being harmful to the environment. Therefore, a service connection utilizing a removable valve assembly must also be highly reliable and designed to prevent leakage or escape of refrigerant from the closed loop cooling system. This is especially important when manufacturing and service personnel are using the valves, during which time the personnel may inadvertently loosen or even remove the valve assembly, which can lead to refrigerant leakage and escape.

### SUMMARY OF THE INVENTION

The invention pertains to improved valves, particularly service connection valves for use on refrigeration systems and the like to permit charging, evacuation and/or testing of the system. The invention described herein could also be used in other systems in other industries in which a valve is used to control flow into and out of a system containing a fluid.

In one embodiment, the valve includes a valve seat, a valve body detachably connected to the valve seat, and a valve core detachably secured within the valve body. The valve body and valve core are removable together as a single unit from the valve seat.

In another embodiment, the valve includes a valve seat, a valve body detachably connected to the valve seat, and a cap. The valve body and valve seat include a first, angled contact area. The valve body and cap include a second, angled contact area. The relationship between the angles of the first and second contact areas is such that as the cap is threaded onto the valve body, the valve body is wedged tighter into the valve seat. The friction force provided by the first contact area is always greater than the friction provided by the second contact area so that the action of unscrewing the cap from the valve body will never cause the valve body to be unscrewed from the valve seat. Therefore, unscrewing the cap from the valve body will never loosen the connection between the valve body and the valve seat, thereby preventing leakage between the valve body and valve seat.

In another aspect of the invention, a valve is provided that includes a one-piece body having a first end and a second end, and an interior wall defining a flow passage between the first and second ends. The interior wall of the body includes a valve seat, and a threaded section. A valve assembly is disposed within the flow passage for controlling flow through the passage. The valve assembly includes a spacer disposed within the one-piece body, a valve stem slidably supported by the spacer, and a valve head disposed at an end of the valve stem. In addition, the spacer includes threads that are engageable with the threaded section whereby the spacer can be inserted into the one-piece body.

A variety of additional advantages of the invention will be set forth in part in the description which follows, and in part will be obvious from the description, or may be learned by practice of the invention. The advantages of the invention will be realized and attained by means of the elements and combinations particularly pointed out in the claims. It is to be understood that both the foregoing general description and the following detailed description are exemplary and explanatory only and are not restrictive of the invention as claimed.

### BRIEF DESCRIPTION OF THE DRAWINGS

FIG. 1 is a cross-sectional view of a service connection valve utilizing a valve core.

FIG. 2 illustrates a service connection valve with contact areas to prevent inadvertent removal of the valve body.

FIG. 3 illustrates the valve body and the valve core from FIG. 2 removed from the valve seat.

FIG. 4 illustrates a service connection valve with a one-piece body.

FIG. 5 illustrates another embodiment of a service connection valve with a one-piece body.

FIG. 6 illustrates yet another embodiment of a service connection valve with a one-piece body.

FIG. 7 illustrates another embodiment of a service connection valve with a one-piece body.

FIG. 8 illustrates yet another embodiment of a service connection valve with a one-piece body.

### DETAILED DESCRIPTION

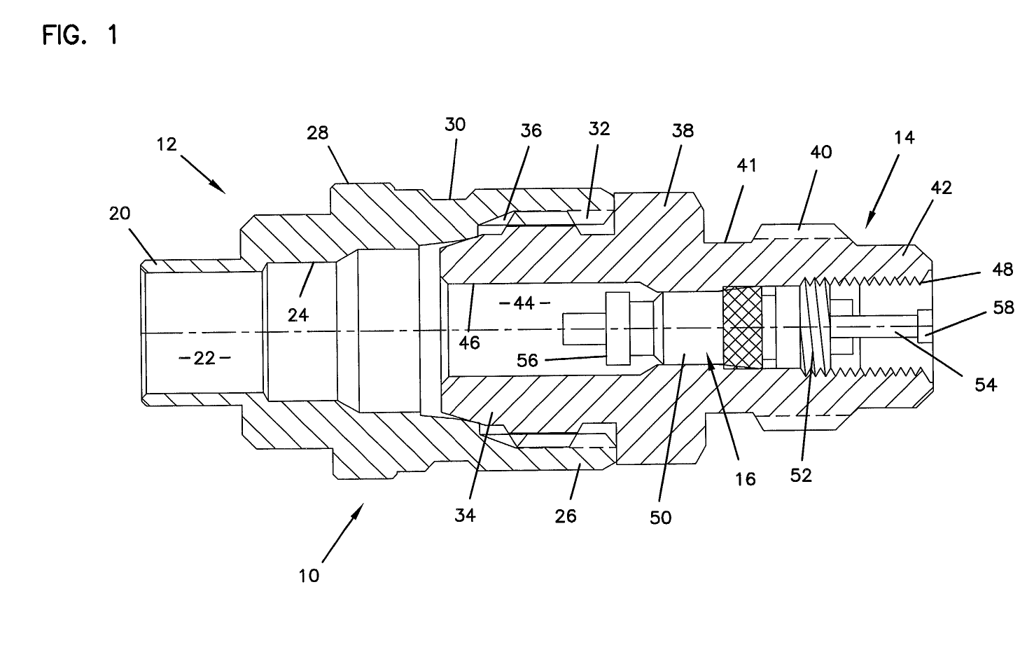

With reference now to FIG. 1, a service connection valve 10 in accordance with the invention is illustrated in detail. The valve 10, as well as the other service connection valves described herein, has particular use in connection with refrigeration systems, including air conditioning systems, refrigerators and the like, to permit charging, evacuation, and/or testing of the air conditioning system during manufacturing, as well as by service personnel out in the field. However, the service connection valves described herein could be used in connection with other systems that utilize a valve core. For instance, the valves could be used on fuel rails on fuel injection systems, on propane tanks, and other systems which utilize a valve core that controls fluid flow into and out of the system. The phrase “service connection valve” is meant to encompass valves of the type similar to those described herein, which control fluid flow into and out of a system.

The valve 10 is comprised of three components: a valve seat 12, a valve body 14, and a valve core 16. The valve seat 12 and valve body 14, which are formed from a metal such as brass, cooperate together to define a flow path through which a fluid, such as a refrigerant, is able is flow. The valve core 16 controls fluid flow through the valve 10.

As used herein, valve core refers to a type of valve commonly referred to in industry as a Schrader valve. Similar valves are sometimes called Eaton valves or stovepipe valves. The term “valve core” is meant to encompass each of these types of valves, and equivalent valves.

The valve seat 12 is generally cylindrical and includes a first end region 20 that is illustrated as having a diameter that is reduced compared with the remainder of the valve seat. It is to be realized that the end region 20 could have a diameter that is about equal to, or greater than, the remainder of the valve seat 12, the diameter of the end region 20 dependent upon the system to which the valve seat connects to. In the preferred use, the valve seat 12 is fixed to the refrigeration system in fluid communication with the closed loop cooling system by suitably securing the end region 20 to the refrigeration system, such as by brazing or welding. A central passage 22 defined by an interior wall 24 of the valve seat 12 extends from the first end region 20 to a second end region 26 of the valve seat. The seat 12 includes a hex head 28 formed thereon to permit engagement by a tool, such as a wrench, and a cylindrical detent groove 30 is provided to facilitate engagement by a connector, such as a latching ball connector. Moreover, the interior wall 24 of the seat 12 is provided with threads 32 adjacent the end region 26.

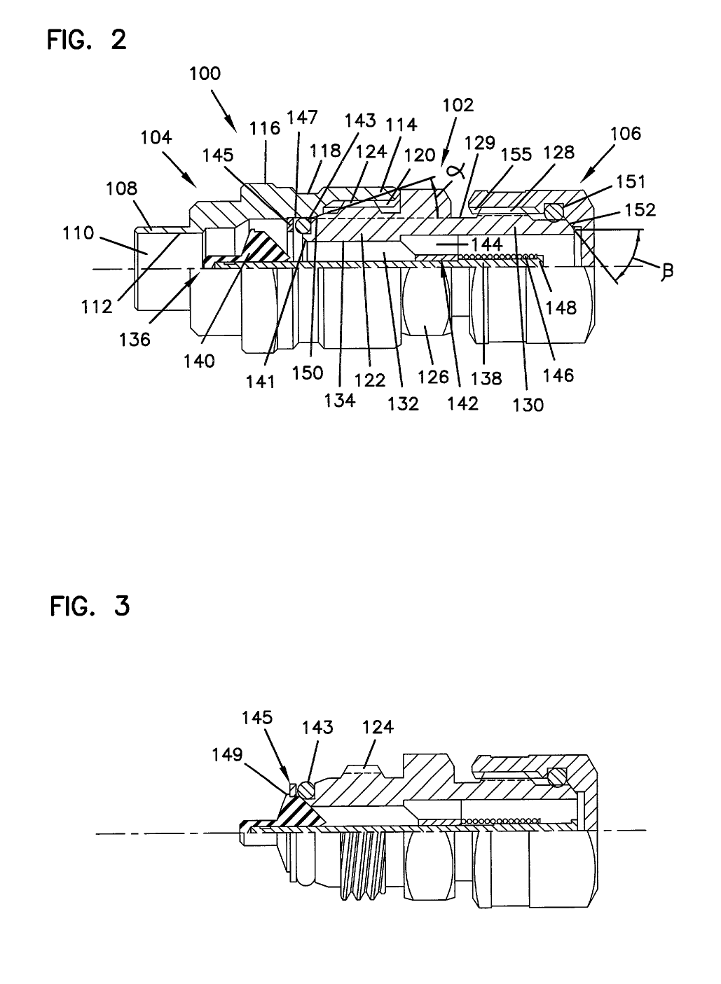

The valve body 14 is also generally cylindrical, and includes an end region 34 that in use is disposed within the end region 26 of the seat 12. The end region 34 is provided with threads 36 that engage with the threads 32 on the seat 12 whereby the valve body 14 can be secured to, and detached from, the seat 12. A hex head 38 formed on the valve body 14 permits a tool, such as a wrench, to engage the valve body 14 and tighten the joint between the seat and valve body. The hex head 38 also abuts against the end region 26 of the seat 12 and limits insertion of the valve body. Threads 40 on the exterior surface of the valve body 14 permit screwing of an end cap, such as the end cap shown in FIG. 2, onto an end region 42 of the valve body. The valve body 14 further includes a channel 41 defined behind the threads 40. A fluid line connector (not shown) is able to attach either to the threads 40 or it can grip behind the threads in the channel 41.

A central passage 44 defined by an interior wall 46 of the valve body 14 extends from the end region 34 to the end region 42 of the valve body. The passage 44 is aligned with the passage 22 in use and the two passages 22, 44 combine to form a flow path for fluid through the valve 10. In addition, the interior wall 46 is provided with threads 48 adjacent the end region 42. The threads 48 permit removable attachment of the valve core 16 within the valve body 14.

The valve core 16 includes a valve housing 50 through which the fluid flows. The exterior of the housing 50 is provided with threads 52 that mate with the threads 48 so that the valve core 16 can be screwed into place and thereafter removed if necessary by simply unscrewing the valve core 16 from the valve body 14 and replacing the defective valve core with a new valve core. A spring biased valve stem 54 extends longitudinally through the housing 50, and a valve head 56 having a seal is connected to the end of the valve stem 54 for movement integrally therewith. The valve stem 54 is suitably biased such that the valve head 56 is biased into sealed engagement with the housing 50 to prevent flow through the body 14. The valve stem 54 includes an enlarged actuating end 58 that is contacted by a fluid line connector upon connection with the valve 10 so as to push the stem 54 into the body 14, thereby unseating the valve head 56 to allow fluid to flow through the housing 50 and through the valve 10. Valve cores and their operation are well known in the art and further description thereof is not provided herein.

It is apparent from FIG. 1 and the description thereof that the service connection valve 10 readily permits replacement of a defective valve. Specifically, the valve body 14 and valve core 16 can be removed together as a single, one-piece. i.e. integral, unit by unscrewing the valve body 14 from the valve seat 12. Valve cores are small in size and therefore difficult to handle by themselves, usually requiring special tools for removal and insertion. Removal of the valve body 14 together with the valve core 16 eliminates the need for separate handling of the valve core 16 by itself, with the relatively larger size of the valve body 14 facilitating handling and removal using conventional tools. Once the valve body 14 and valve core 16 are removed, manufacturing personnel are provided the benefit of a higher flow through the valve seat 12. Moreover, the use of a valve core, which are widely used in a variety of industries, provides familiarity to service personnel who are familiar with valve cores and their operation, and the same tools that have been used previously to actuate valve cores can be used with the valve 10.

Once the valve body 14 is removed, the defective valve core 16 can be removed and replaced with a replacement valve core. Alternatively, the entire unit comprising the valve body 14 and valve core 16 can be replaced by a new valve body 14 and valve core 16 unit. It is also expected that the valve core 16 itself could be removed from the valve body 14 without removing the valve body 14 from the valve seat 12. However, this would require the special tools mentioned above. Moreover, valve assemblies other than a valve core could be used on the valve 10, provided the other valve assemblies are removable with the valve body.

Turning now to FIG. 2, a service connection valve 100 is illustrated that is designed to prevent inadvertent loosening or removal of a valve body 102 from a valve seat 104 when an end cap 106 screwed onto the valve body 102 is removed.

The valve seat 104 is generally cylindrical and includes a first end region 108 that is illustrated as having a diameter that is reduced compared with the remainder of the valve seat. It is to be realized that the end region 108 could have a diameter that is about equal to, or greater than, the remainder of the valve seat 104, the diameter of the end region 108 dependent upon the system to which the valve seat connects to. In the preferred use, the valve seat 104 is fixed to the refrigeration system in fluid communication with the closed loop cooling system by suitably securing the end region 108 to the refrigeration system, such as by brazing or welding.

A central passage 110 defined by an interior wall 112 of the valve seat 104 extends from the first end region 108 to a second end region 114 of the valve seat. The seat 104 includes a hex head 116 formed thereon to permit engagement by a tool, such as a wrench, and a cylindrical detent groove 118 is provided to facilitate engagement by a connector, such as a latching ball connector. Moreover, the interior wall 112 of the seat 104 is provided with threads 120 adjacent the end region 114.

The valve body 102 is also generally cylindrical, and includes an end region 122 that in use is disposed within the end region 114 of the seat 104. The end region 122 is provided with threads 124 that engage with the threads 120 on the seat 104 whereby the valve body 102 can be secured to, and detached from, the seat 104. A hex head 126 formed on the valve body 102 permits a tool, such as a wrench, to engage the valve body 102 and tighten the joint between the seat and valve body. The hex head 126 also abuts against the end region 114 of the seat 104 and limits insertion of the valve body. Threads 128 on the exterior surface of the valve body 102 permit screwing of the end cap 106 onto an end region 130 of the valve body 102. The valve body 102 further includes a channel 129 defined behind the threads 40. A fluid line connector (not shown) is able to attach either to the threads 128 or it can grip behind the threads in the channel 129.

A central passage 132 defined by an interior wall 134 of the valve body 102 extends from the end region 122 to the end region 130 of the valve body. The passage 110 is aligned with the passage 132 in use and the two passages 110, 132 combine to form a flow path for fluid through the valve 100.

A valve assembly 136 is provided for controlling flow through the valve 100. The valve assembly 136 is supported within the valve body 102 so as to form a part thereof such that when the valve body 102 is removed from the valve seat 104, the valve assembly 136 is removed therewith. The valve assembly 136 includes an elongated valve stem 138 extending through the passage 132 parallel to the longitudinal axis thereof and a valve head 140 is secured to one end of the valve stem 138 adjacent the end region 122 of the valve body 102. The valve head 140 can be a separate part from the stem 138, with the head 140 being suitably fixed to the stem 138 as in FIG. 2. Alternatively, the valve head and stem can be a single, unitary formed piece.

The valve assembly 136 further includes a spacer 142 that is disposed within the passage 132 for slideably supporting the valve stem 138 to allow opening and closing movements of the valve assembly 136. The spacer 142 includes a central sleeve through which the valve stem 138 extends, and a plurality of spacer arms 144 are circumferentially spaced around the sleeve and extend to the interior wall 134 for supporting the central sleeve. There are preferably two or three of the spacer arms 144 in order to provide adequate support for the central sleeve. The spacer 142 can be fixed in the passage 132 in any suitable manner. Preferably, the spacer 142 is press fit into the passage. Alternatively, the arms 144 can be fixed by swaging to the valve body 102, or a snap-ring could be used to fix the spacer 136 in the passage.

The end region 122 of the valve body 102 is further provided with a lip 141, and a seal 143 is disposed around the lip 141. In addition, a washer 145 is provided that floats in, i.e. is movable within, a groove 147 formed in the interior wall 112.

As shown in FIG. 2, when the valve body 102 is threaded into the valve seat 104, the seal 143 is disposed between the end region 122 and the washer 145. Further, the seal 143 is radially squeezed between the lip 141 and the seat 104 to prevent fluid leakage between the valve seat and valve body, and to capture the seal 143 to prevent seal blowout. The lip 141 and the seal 143 further form valve seats against which the valve head 140 engages to close off flow through the valve 100.

However, as shown in FIG. 3, when the valve body 102 and valve assembly 136 are removed as a unit from the valve seat 104, a lip 149 on the valve head 140 contacts the washer 145 and pulls the washer 145 from the valve seat. Thus, the washer 145 encapsulates the seal 143 so that the seal will not come off during removal of the valve body from the valve seat. The washer 145 is retained in place by the lip 149 and by the seal 143.

A coil spring 146 surrounds the valve stem 138 and is engaged between the sleeve of the spacer 142 and an enlarged end 148 of the valve stem so as to bias the valve stem 138 and valve head 140 to the right in FIG. 2 whereby the valve head is normally biased into sealed engagement with the seal 143, as well as with the lip 141 to provide a metal to metal seal as a back-up to the seal 143. Thus, flow through the valve 100 is prevented until the valve stem 138 is biased to the left against the bias of the spring 146 which unseats the valve head 140. In the normally closed position of the valve assembly, the enlarged end 148 is disposed adjacent to or projects slightly beyond the end of the valve body 102, to facilitate actuation of the valve stem 138. However, the enlarged end 148 need not extend beyond the end of the valve body 102, but could instead be disposed completely within the valve body.

The cap 106, which is to be screwed onto the end region 130 of the valve body 102, includes threads 155 that mate with the threads 128. Further, the cap 106 is provided with a seal 151 that seals with an exterior surface of the valve body 102 at the end region 130 to prevent fluid leakage.

As indicated above, the valve 100 is designed to prevent loosening of the valve body 102 when the cap 106 is unscrewed therefrom. It has been discovered that when a cap is unscrewed from a valve, the valve body can often times be loosened from the valve seat through the forces associated with unscrewing the cap. Thus, unscrewing the cap can inadvertently cause the valve body to be loosened, thereby potentially breaking seal and allowing fluid to escape. The valve 100 is designed to preclude loosening of the valve body 102 due to unscrewing of the cap 106.

In FIG. 2, it is seen that the valve body 102 and valve seat 104 have a contact area 150 over which the valve body and valve seat contact each other when the valve body is screwed into the valve seat. The contact area 150 is defined by a contact surface on the valve seat and a contact surface on the valve body. Prior to insertion of the valve body, the contact surface of the valve seat is disposed at a first angle and the contact surface of the valve body is disposed at a second angle that is greater than the first angle. In one implementation, the first angle is about 10 degrees and the second angle is about 16 degrees. These angles are exemplary only, and it is to be realized that other angles could be used.

When the valve body is threaded into the valve seat, the contact surfaces engage each other to form the contact area. Deformation of the contact surfaces occurs when the body is inserted, such that the contact area is disposed at an angle α relative to a longitudinal axis through the valve 100, with the angle a being between the first angle and the second angle. With the exemplary angles of about 10 degrees and about 16 degrees mentioned above, the angle a of the contact surface 150 will be between about 10 and about 16 degrees. The contact area 150 provides a metal-to-metal seal and provides increased friction to prevent the valve body 102 from being easily removed from the valve seat 104.

In addition, the cap 106 and the valve body 102 have a contact area 152, defined by contact surfaces on the valve body and cap, over which the cap and valve body contact each other when the cap is screwed onto the valve body. The contact area 152 provides a metal-to-metal seal that is in addition to the seal 151.

The contact area 152 is disposed at an angle β relative to a longitudinal axis through the valve 100. The angle β is larger than the angle α. Using the exemplary angles mentioned above, the angle a is about 11.0°, while the angle β is about 45.0°. However, other angles could be used if desired. Moreover, the contact area 150 is larger than the contact area 152. In one implementation, the contact area 150 is about 24% larger than the contact area 152. Other area relationships can be used, as long as the contact area 150 is larger than the contact area 152. With this design, less force is needed to remove the cap due to the relatively larger angle β, compared to the angle α.

It has been discovered that the contact area 150, which is larger than contact area 152 and disposed at a shallower angle, has greater surface area and thus a larger frictional force than the contact area 152. The combination of larger surface area and increased frictional force means that the valve body 102 requires more torque to remove or loosen from the valve seat 104 than what is required to remove the cap 106 from the valve body 102. Thus, during removal of the cap 106, the cap will always loosen from the valve body 102 before the valve body loosens from the valve seat 104. Inadvertent loosening of the valve body from the valve seat is therefore prevented during removal of the cap from the valve body.

The particular valve assembly used with the valve 100 is irrelevant, as long as the valve assembly permits the contact areas 150, 152. Thus, the valve assembly could be a valve core as in FIG. 1, any of the valve assemblies found in U.S. Pat. No. 6,050,295, or other similar valve assemblies. Moreover, the contact surfaces discussed with respect to FIG. 2 could be used in the valve 10 illustrated in FIG. 1.

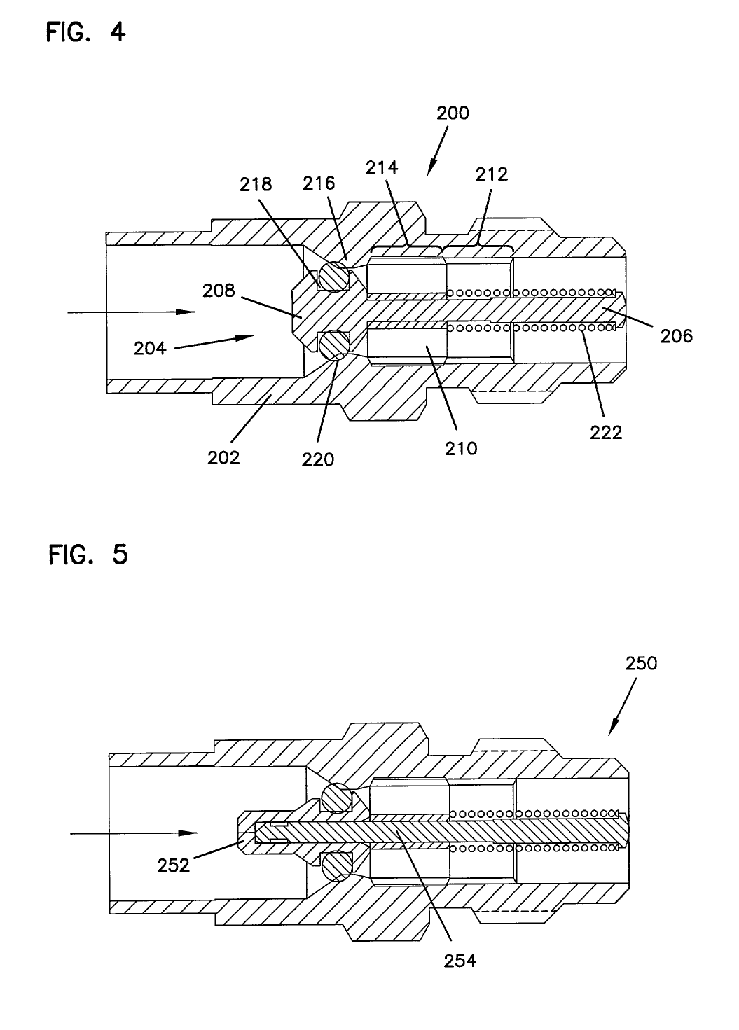

FIGS. 4-6 illustrate service connection valves that utilize a one-piece valve body instead of a valve seat and valve body as in FIGS. 1-3. A service connection valve using a one-piece body is disclosed in U.S. Pat. No. 6,050,295. It has been discovered that the spacer in the one-piece body of that patent can be damaged if a person continues to try to thread the spacer into the body after the spacer has been fully inserted.

In FIG. 4, a valve 200 is shown with a one-piece body 202. The exterior construction of the one-piece body 202 is similar to exteriors of the valve seat and valve body of FIGS. 1-2 and is not further described. A valve assembly 204 is supported within the one-piece body 202 for controlling flow therethrough. The valve assembly 204 is similar to the valve assembly 136 in FIG. 2 in that the valve assembly 204 includes a valve stem 206, valve head 208 and a spacer 210.

The spacer 210 is similar to the spacer 142, however the ends of the spacer arms are formed with threads, that are designed to engage with a threaded section 212 formed on the interior wall of the one-piece body 202. The threaded section 212 extends over a limited portion of the inner surface. A relief groove 214 is provided between the end of the threaded section 212 and a reduced diameter valve seat portion 216. The relief groove 214 is not threaded and is sized such that when the spacer 210 is fully within the groove 214, the spacer 210 can freely rotate relative to the groove 214 without causing the spacer to be advanced further into the body.

By reducing the extent of the threads, flow restriction provided by the threads is minimized. In addition, the relief groove 214 prevents a person from threading the spacer 210 to tightly into the valve. The spacer 210 initially engages the threads 212 while it is being inserted into the body. Eventually, the spacer 210 clears the threads 212 and is fully within the relief groove 214 as shown in FIG. 4. Because the groove 214 is not threaded and the spacer 210 can rotate in the groove, further attempts to advance the spacer further into the body will simply cause the spacer 210 to rotate in the groove without the spacer moving further into the body. Therefore, damage caused by over-torqueing of the spacer 210 is prevented.

In addition, the valve head 208 is illustrated as being integrally formed with the stem 206. This design eliminates the need to assemble and fasten together the head and stem. The reduced diameter valve seat portion 216 has an inner diameter slightly greater than the largest outer diameter of the valve head 208 to permit removal of the valve assembly from the one-piece body and replacement with a new valve assembly. Removal is achieved by unscrewing the spacer 210, during which time a suitable force acting on the spacer to the right in FIG. 4, provided by internal pressure or by a tool, is needed to initially engage the threaded section 212.

In addition, in case the valve assembly does not need to be made removable, the valve assembly could be secured within the one-piece body 202 by suitable permanent securement means.

The valve head 208 further includes a radially outward facing groove 218 formed therein, and a seal 220 is disposed in the groove 218 for sealing engagement with the valve seat portion 216 when the valve head is biased by a spring 222 to the right, as shown in FIG. 4. The seal is illustrated as an o-ring seal, but it could also be a square elastomer seal. In addition, the seal can be secured, such as by bonding, within the groove 218 to prevent seal blowout. Operation of the valve 200 is believed to be evident from the description of its parts, as well as from U.S. Pat. No. 6,050,295.

FIG. 5 is similar to FIG. 4, but shows a valve 250 with a valve head 252 that is attached to a valve stem 254, such as being swaged thereto. The valve 250 is otherwise the same as the valve 200.

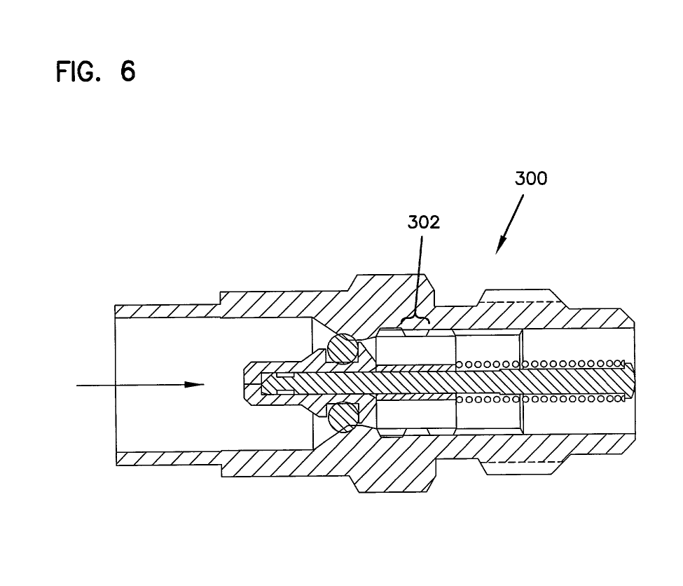

FIG. 6 illustrates a valve 300 that is similar to the valve 250. However, in the valve 300, a minimal threaded section 302 is provided, and the relief groove that completely receives the spacer is not provided. There are no threads provided between the end of the spacer and the right end of the valve 300. This design eliminates any flow restriction provided by threads to the right of the spacer.

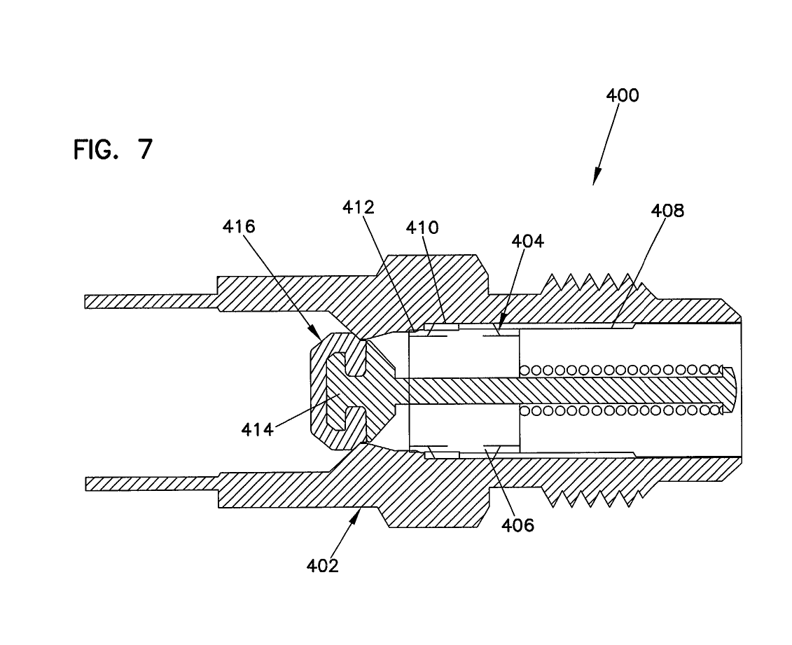

In FIG. 7, an alternative embodiment of a valve 400 with a one-piece body 402 is illustrated. The valve 400 includes a spacer 404 with threads 406 disposed between the ends of the spacer 404. The interior surface of the body 402 is provided with threads 408 and a recess 410 where no threads are present. The left end of the spacer 404, which is not threaded, engages with the interior surface of the body 402 at contact area 412. As a result, a wedging action is produced which limits insertion of the spacer 404 into the body 402 and helps retain the spacer 404 within the body 402. In addition, the valve head 414 is provided with a molded rubber seal 416 that engages with the valve seat formed on the interior surface of the body 402.

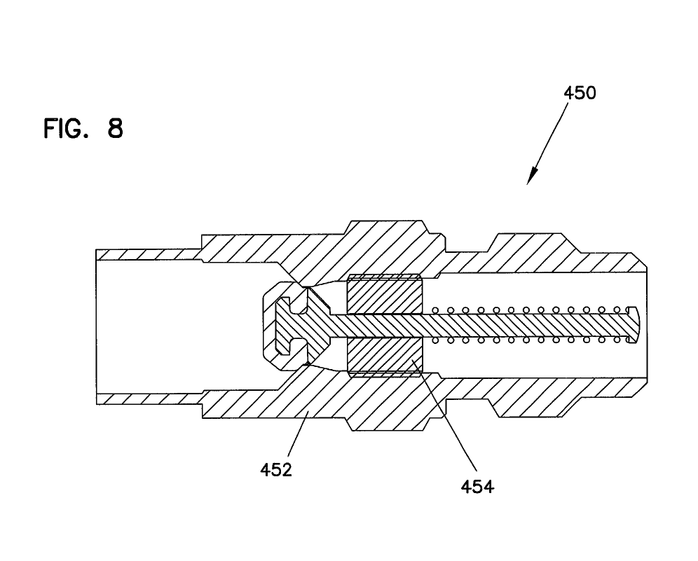

FIG. 8 illustrates a valve 450 with a one-piece body 452. The valve 450 includes a spacer 454 that is threaded along the entire length thereof for engagement with corresponding threads on the interior surface of the body 452.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A valve comprising:
a valve seat having a first end and a second end and having a flow passage between said first and second ends;
a valve body detachably connected to said valve seat whereby said valve body is removable from said valve seat, said valve body including a flow passage extending between first and second ends thereof; and
a valve core disposed in the flow passage of said valve body whereby said valve core is removable with said valve body.

2. A valve according to claim 1, wherein said valve core is detachably connected to said valve body whereby said valve core is removable from said valve body.

3. A valve according to claim 1, wherein said valve core comprises:
a housing;
a valve head connected to a valve stem; and
a biasing mechanism engaged with said valve stem biasing the valve head into engagement with said housing.

4. A valve according to claim 3, further including threads on an exterior surface of said housing, said threads being engaged with threads on an interior surface of said valve body.

5. A valve according to claim 1, further including threads on said valve body that are engaged with threads on said valve seat whereby said valve body is connected to said valve seat.

6. A valve according to claim 1, wherein the second end of said valve body projects beyond the second end of said valve seat, and further including threads on an exterior surface of said valve body adjacent the second end of said valve body.

7. A valve according to claim 6, further including a channel on the exterior surface of said valve body adjacent said threads.

8. A valve according to claim 7, further including a detent groove on an exterior surface of said valve seat between the first and second ends thereof.

9. A valve comprising:
a valve seat having a first end and a second end and having a flow passage between said first and second ends;
a valve body having a first end and a second end, the first end of said valve body being disposed within the second end of said valve seat and detachably connected to said valve seat whereby said valve body is removable from said valve seat, said valve body including a flow passage extending between the first and second ends thereof; and
a valve assembly connected to said valve body within the flow passage thereof for controlling flow through the flow passage, said valve assembly is removable with said valve body from said valve seat and said valve assembly includes a valve stem with first and second ends, the first end of said valve stem extends toward said second end of said valve body and a valve head is connected to the second end of said valve stem and is disposed entirely within the flow passage of said valve body.

10. A valve according to claim 9, wherein said valve assembly is detachably connected to said valve body whereby said valve assembly is removable from said valve body.

11. A valve according to claim 9, wherein the second end of said valve body projects beyond the second end of said valve seat, and further including threads on an exterior surface of said valve body adjacent the second end of said valve body.

12. A valve according to claim 11, further including a channel on the exterior surface of said valve body adjacent said threads.

13. A valve according to claim 12, further including a detent groove on an exterior surface of said valve seat between the first and second ends thereof.

14. A valve according to claim 10, wherein said valve assembly comprises a valve core having a housing, a valve head connected to a valve stem, and a biasing mechanism engaged with said valve stem biasing the valve head into engagement with said housing.

15. A valve comprising:
a valve seat having a first end and a second end, and having a flow passage between said first and second ends, said valve seat further including a contact surface;
a valve body detachably connected to said valve seat whereby said valve body is removable from said valve seat, said valve body including a flow passage extending between first and second ends thereof, and the second end of said valve body projects beyond the second end of said valve seat, and said valve body includes a first contact surface and a second contact surface, the first contact surface contacting the contact surface of said valve seat to define a first contact area;
a valve assembly connected to said valve body within the flow passage thereof for controlling flow through the flow passage;
a cap connected to the second end of said valve body, said cap including a contact surface contacting the second contact surface of said valve body to define a second contact area; and
wherein the second contact area is disposed at an angle relative to a longitudinal axis through the valve that is larger than an angle of the first contact area.

16. A valve according to claim 15, wherein the first contact area is larger than the second contact area.

17. A valve comprising:
a one-piece body having a first end and a second end, and an interior wall defining a flow passage between the first and second ends, said interior wall further including a valve seat, and a threaded section;
a valve assembly disposed within the flow passage controlling flow through the passage, said valve assembly including a spacer disposed within the one-piece body, a valve stem slidably supported by said spacer, and a valve head disposed at an end of said valve stem; and
wherein said spacer includes threads that are engageable with said threaded section whereby said spacer can be inserted into said one-piece body.

18. A valve according to claim 17, wherein the interior wall further includes a non-threaded section between the threaded section and the valve seat.

19. A valve according to claim 18, wherein said spacer is disposed entirely within said non-threaded section.

20. A valve according to claim 18, wherein at least a portion of said threads of said spacer are positioned at said non-threaded section when said spacer is fully inserted.

21. A valve according to claim 17, wherein said threads of said spacer extend along the entire length of said spacer.

22. A valve comprising:
a valve seat having a first end and a second end, and having a flow passage between said first and second ends, said valve seat further including a groove formed in an interior wall thereof;
a washer slidably disposed within said groove;
a valve body detachably connected to said valve seat whereby said valve body is removable from said valve seat, said valve body including a flow passage extending between first and second ends thereof, and the second end of said valve body projects beyond the second end of said valve seat, and the first end of said valve body includes a lip;
a seal disposed between said lip and the interior wall of said valve seat, and disposed between said washer and an end surface of said valve body; and
a valve assembly connected to said valve body within the flow passage thereof for controlling flow through the flow passage, said valve assembly is removable with said valve body from said valve seat, and said valve assembly includes a valve head with a projecting lip positioned on the side of said washer opposite said seal whereby upon removal of said valve body and said valve assembly from said valve seat, said projecting lip pulls said washer from said valve seat.
